(19) United States
(12) Patent Application Publication
(10) Pub. No.: US 2025/0069451 A1
(43) Pub. Date: Feb. 27, 2025

(54) Method and System for Issuing a Feedback Request for a Feedback Situation of a Vehicle

(71) Applicant: Bayerische Motoren Werke Aktiengesellschaft, Muenchen (DE)

(72) Inventors: Alexander BUSCH, Planegg (DE); Ken-Jiro WALDOE, Tuerkenfeld (DE)

(21) Appl. No.: 18/804,541

(22) Filed: Aug. 14, 2024

(30) Foreign Application Priority Data
Aug. 21, 2023 (DE) 10 2023 122 324.0

(51) Int. Cl. G07C 5/08; B60Q 9/00

(52) U.S. Cl. CPC G07C 5/0816; B60Q 9/00

(57) ABSTRACT

In a method for issuing a feedback request for a feedback situation of a vehicle, at least one item of vehicle information is ascertained. A time at which the feedback request is to be issued is determined according to the feedback situation of the vehicle and based on the at least one item of vehicle information. In another aspect, a system for issuing a feedback request on a feedback situation of a vehicle is provided.

### CROSS REFERENCE TO RELATED APPLICATION

This application claims priority under 35 U.S.C. § 119 from German Patent Application No. 10 2023 122 324.0, filed Aug. 21, 2023, the entire disclosure of which is herein expressly incorporated by reference.

### BACKGROUND AND SUMMARY

The invention relates to a method for issuing a feedback request for a feedback situation of a vehicle. The invention further relates to a system for issuing a feedback request for a feedback situation of a vehicle.

The request for user feedback on products or services is used in principle, for example, to collect information for improvements to these products or services in development or to prioritize these improvements. These requests are regularly controlled by fixed temporal timers, for example after an online shopping process has been completed. These fixed requests are often ineffective and result in insufficient feedback, because the requests are either not answered at all or the content thereof is only superficial. This also applies to vehicles for which, in addition, a request for user feedback must not restrict driving safety either.

Document U.S. Pat. No. 10,532,749 B2 discloses the request for feedback from occupants of an autonomously driving vehicle following an event during travel in the autonomously driving vehicle.

Document US 2019/0225232 A1 discloses the request for feedback from occupants of an autonomously driving vehicle. In particular, the request can be made periodically at a preset interval after an event.

Document US 2019/0391581 A1 discloses the request for a state of health of an occupant of a vehicle.

The object of the invention is to provide a method and a system for issuing a feedback request for a feedback situation of a vehicle in which the issuing of the feedback request is performed safely and effectively.

This object is achieved by a method and system for issuing a feedback request for a feedback situation of a vehicle having the features of the independent claim(s). Advantageous developments are specified in the dependent claims.

In the proposed method for issuing a feedback request for a feedback situation of a vehicle, at least one item of vehicle information is ascertained. A time at which the feedback request is to be issued is ascertained according to the feedback situation of the vehicle and based on the at least one item of vehicle information.

The vehicle information can be ascertained in particular before, during and/or after the feedback situation. The time for requesting feedback is ascertained temporally according to the feedback situation; in particular, vehicle information that is ascertained according to the feedback situation can thus also be taken into account. The feedback request is thus not only issued fixedly after a preset time interval that follows the feedback situation, but the feedback request is ascertained dynamically or flexibly based on the feedback situation and the vehicle information. This achieves a situation in which the feedback request is made at an appropriate time after the feedback event. By taking into account the vehicle information, it is thus possible, for example, to issue the feedback request at a time when a disruption or distraction for a driver or occupant of the vehicle is avoided. Furthermore, it is possible, for example, to avoid the feedback request interrupting the activities of the driver or occupants of the vehicle by taking into account the vehicle information. The method can be used to ascertain a time for the feedback request at which an addressee of the feedback request can dedicate themselves to the feedback request and is able to provide feedback. By adjusting the timing of the feedback request, the feedback request can be particularly effective and can also be answered. Furthermore, it is also possible to minimize or prevent impairment of the safety of the vehicle occupants. The feedback request is preferably issued at the time ascertained by the method, for example as an active invitation to provide feedback.

The vehicle information may include, for example, information that can be ascertained by means of the vehicle, for example by means of sensors or control units of the vehicle. The vehicle information may thus include, in particular, inputs or commands from drivers or users of the vehicle, information generated locally from sensors of the vehicle, or information transmitted to the vehicle from external devices or retrieved by the vehicle. For example, the feedback situation may be a situation or an event that arises during or through the use of the vehicle. Feedback on this feedback situation should then be requested. This means that the feedback request is made in particular in relation to the feedback event.

The feedback situation is preferably ascertained based on the at least one item of vehicle information. In particular, the feedback situation is first ascertained based on the ascertained vehicle information and then based on the feedback event, and a time is ascertained for the output of the feedback request based on the ascertained vehicle information. This enables the feedback situation to be ascertained particularly precisely. This means that the feedback request time is at least partially ascertained using the same vehicle information that was used to ascertain the feedback situation. This also allows the feedback request time to be ascertained particularly precisely.

It is also advantageous if the at least one item of vehicle information includes at least one item of information that is ascertained by means of a sensor or a control unit of the vehicle. This enables the feedback request time to be ascertained particularly accurately and relevantly. For example, a speed of the vehicle can be ascertained as vehicle information. Information about the driver or the occupants can also be ascertained.

The at least one item of vehicle information preferably includes at least one item of information that is transmitted from an external device to the vehicle. The external device may be for example an access control device or a payment terminal. This enables the feedback request time for many different feedback situations to be ascertained accurately. In particular, the external device is located close to the vehicle and in particular connected to the vehicle via a cable or wirelessly. For example, the time of a feedback request for a parking or payment process in a multi-story car park can be ascertained.

It is particularly preferred that the at least one item of vehicle information includes at least one item of information relating to a charging station or fuel station. This makes it possible to ascertain a time to request feedback in relation to a charging or refueling process. For example, the charging station may be an electric charging station that can be used to charge a battery of the vehicle. This charging station is usually outside of the vehicle. Furthermore, it is connected to the vehicle, in particular by way of a charging cable, for charging the battery. The vehicle information may thus include in particular information about the charging station, for example with regard to a charging current, the connections available on the charging station or charging cables or the charging power.

The at least one item of vehicle information preferably includes at least one state of charge or fuel tank level of the vehicle. The state of charge may be for example the level of charge of a battery of the vehicle. The vehicle information may also include the battery capacity. This makes it possible to ascertain the time to request feedback in relation to a vehicle charging or refueling process.

The vehicle information may also include in particular at least one of the following items of information: driver or occupant input, for example a navigation destination in a navigation device of the vehicle, a position or location of the vehicle, possibly immediately upcoming navigation maneuvers based on the location of the vehicle and the navigation destination, a traffic density, in particular in the form of a number of road users around the vehicle, a speed of the vehicle, the weather, in particular at the location of the vehicle, the time of day or season, in particular at the location of the vehicle, or the number of vehicle occupants.

The feedback request is preferably issued at a time when the vehicle is in an urban environment and is stationary. The position of the vehicle can be ascertained for this purpose. An urban environment is for example an inhabited area or a metropolitan area, especially a city. Since increased attention is often required by vehicle occupants, in particular the driver, in an urban environment, in this case the feedback request can be issued at a time when the vehicle is stationary. This allows vehicle occupants to focus on the feedback request and then respond to the feedback request.

The feedback request is preferably issued at a time when the vehicle is on a highway or in a rural environment and is in motion. Overland journeys do not regularly require continuous attention from vehicle occupants, and so a feedback request can also be effectively issued even when the vehicle is in motion.

The content of the feedback request is preferably ascertained based on the at least one item of vehicle information. This enables a feedback request that is relevant in terms of content. Furthermore, it is particularly preferred that the content of the feedback request is ascertained based on the ascertained vehicle information and the feedback event. By also matching the content of the feedback request to the feedback event, it is possible to issue a particularly effective feedback request.

It is preferred that the at least one item of vehicle information includes a driver's attention and the time of the feedback request is ascertained based on the driver's attention. In particular, the feedback request is thus issued at a time when a high degree of attention from the driver for answering the feedback request is ascertained and so the feedback request is also answered. The driver's attention can be ascertained for example by means of a sensor, in particular a camera, of the vehicle. In addition, the driver's attention can be ascertained based on further vehicle information, for example a time until a next navigation maneuver. If navigation maneuvers are imminent based on the navigation destination, the driver's attention to further tasks is likely to be reduced than if a longer uninterrupted distance on a highway is imminent.

It is preferred to issue the feedback request to a vehicle occupant, in particular to at least one driver of the vehicle. The issuing can be carried out via an output unit of the vehicle. This enables a particularly relevant response to the feedback request.

Feedback information is preferably ascertained based on a response to the feedback request. This allows the collection and processing of the feedback information. Likewise, failure to respond to the feedback request within a time interval can be ascertained as feedback information.

It is particularly preferred that the feedback information is forwarded to other vehicles and/or to an evaluation unit. The evaluation unit may be in particular outside of the vehicle, for example a central server. This makes it easy to further process the feedback information.

The at least one item of vehicle information preferably includes at least the item of feedback information of a first feedback request and the time, in particular also the content, of further feedback requests is ascertained based on the feedback information. This enables the time for requesting feedback to be personalized to a driver or occupant of the vehicle. In addition, the identity of the driver can be used as vehicle information for personalization for several drivers.

The invention further relates to a system for issuing a feedback request for a feedback situation of a vehicle, comprising means that are adapted to carry out the steps of the method according to any one of the preceding claims. The system may comprise in particular a control unit that is adapted to carry out the steps of the method, which control unit may be processor, hardware and/or software based.

The system has the same advantages as the claimed method. In particular, the system may be developed with the features of the dependent claims directed to the method and the further features mentioned in this document in connection with the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective schematic illustration of a cockpit of a vehicle; and

FIG. 2 is a flowchart of a method for issuing a feedback request for a feedback situation of a vehicle.

### DETAILED DESCRIPTION OF THE DRAWINGS

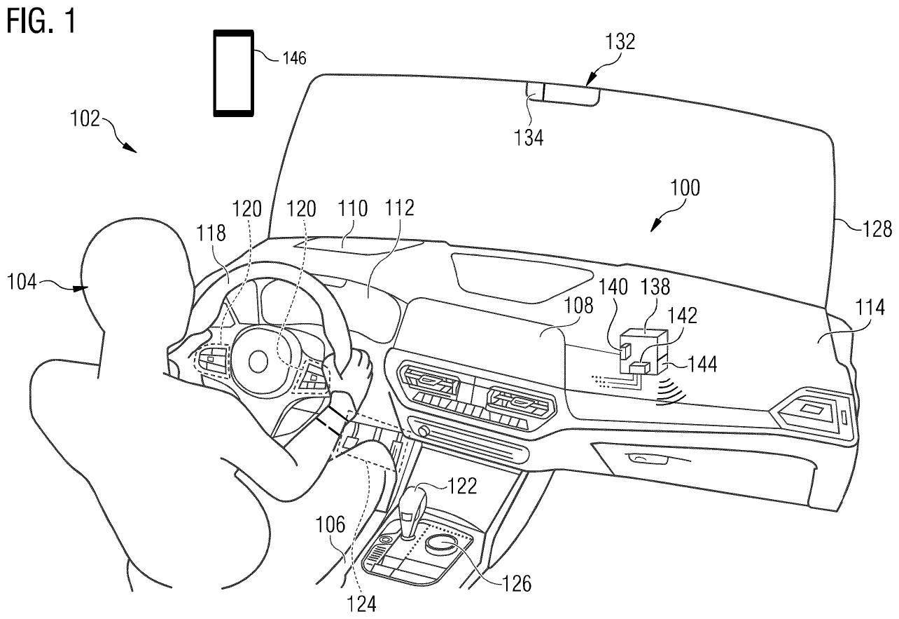

FIG. 1 shows a perspective schematic illustration of a cockpit 100 of a vehicle 102. A driver 104 sits on a driver seat 106 of the vehicle 102. The cockpit 100 also comprises a central information display (CID) 108, a head-up display 110 and a graphical instrument cluster 112, which are arranged in a dashboard 114 of the vehicle 102. The aforementioned display elements 108, 110, 112 each form a functional unit of an output unit of the vehicle 102, which is designed to output information to the driver 104 and/or other occupants.

The cockpit 100 further comprises a steering wheel 118 with operator control elements 120, a gear selector switch 122, pedals 124 and an input unit 126 with a rotary wheel and a push button function and/or a touch input field. This input unit 126 is also referred to as the Ergo Commander.

An interior rearview mirror 132 and an interior camera 134 integrated in this interior rearview mirror 132 are arranged in the upper region of a windshield 128 of the vehicle 102. The camera 134 is designed and integrated in the rearview mirror 132 in such a way that it captures images with a depiction of at least one region of the interior of the vehicle 102. Specifically, the field of view of the camera 134 is directed in the direction of the driver seat 106 and a passenger seat of the vehicle 102. The camera 134 is designed in particular to capture several temporally successive images in particular in the form of a video stream in order to generate corresponding image data and to transmit these data to a control unit 138 used as a processing unit.

The control unit 138 has data outputs 140 and data inputs 142, which are used for connection to further units of the vehicle 102, for example to further cameras, sensors, input and output units and control units of assistance systems. The vehicle thus has at least one collision detection unit for detecting a risk of the vehicle 102 colliding with another object. The collision detection unit may comprise at least one front camera for capturing images of a region in front of the vehicle 102, a radar sensor, a lidar sensor and/or another sensor suitable for monitoring the environment of the vehicle 102.

The control unit 138 further comprises a communication module 144, which is designed to establish a connection to a telecommunications network, in particular to a mobile network. Car-to-car communication and infrastructure-to-car communication are also easily possible via this communication module 144.

The control unit 138 may be in particular part of a system for issuing a feedback request for a feedback situation of the vehicle 102. The control unit 138 is then designed to perform the method for issuing a feedback request for a feedback situation of the vehicle 102.

The vehicle 102 may comprise in particular an internal combustion engine and/or an electric motor for the purpose of movement. The electric motor may be operated using a battery of the vehicle 102. This battery can be connected to a charging station 146 in order to charge the battery.

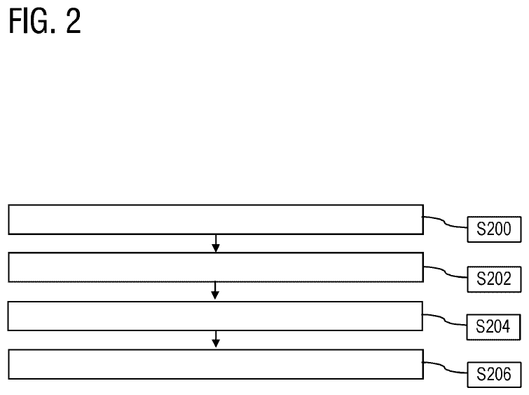

FIG. 2 shows a flowchart of a method for issuing a feedback request for a feedback situation of a vehicle. The method starts in step S200. At least one item of vehicle information is ascertained in step S202. A large amount of different vehicle information is preferably ascertained in step S204. The vehicle information can be ascertained in particular by sensors and/or control units of the vehicle 102. For example, the vehicle information may be the attention of a driver 104 ascertained by use of the interior camera 134. For this purpose, in particular, a viewing activity of the driver 104 can be monitored by way of the interior camera 134. As a further example, the vehicle information may include interactions of the driver 104 or the occupants of the vehicle 102 with operator control elements of the vehicle 102, in particular with the input unit 126 or the operator control elements 120. This vehicle information can be ascertained in particular by the control unit 138.

Further vehicle information can furthermore be ascertained by means of the control unit 138, in particular through communication with external devices via the communication interface 144. For example, a position of the vehicle 102 can thus be ascertained by means of a global navigation satellite system. The weather or a weather forecast can also be ascertained for this position as vehicle information. Furthermore, the ascertained position of the vehicle 102 and map data in the control unit 138 can be used to ascertain whether the vehicle 102 is in an urban or rural environment. Furthermore, the control unit 138 can process navigation data and ascertain the time distance or spatial distance to the next driving maneuver, for example a turning maneuver, in the case of active route guidance based on the position of the vehicle 102.

Furthermore, the control unit 138 can communicate with the charging station 146, in particular when the vehicle 102 is close to the charging station 146. The communication can be carried out wirelessly via the communication interface 144 and/or via a charging cable connected to the vehicle 102. For example, a charging power available at the charging station 146 or connections available at the charging station 146 or charging cables can be transmitted and thus be ascertained as vehicle information. Furthermore, a battery capacity of the battery of the vehicle 102 or the state of charge thereof can be ascertained as vehicle information. Furthermore, vehicle information, for example a charging time, can be ascertained during a charging process of the vehicle 102.

In step S204, a time at which the feedback request is to be issued is ascertained according to a feedback situation of the vehicle 102 and based on the at least one item of vehicle information. A large amount of vehicle information is preferably used to ascertain the time. For example, the time of the feedback request can be ascertained based on the current attention of the driver 104 and upcoming driving maneuvers. In particular, the time of the feedback request is ascertained when no driving maneuvers are imminent and the driver 104 is not distracted by other tasks or interactions and their attention to the feedback request would be reduced thereby. The feedback request in step S204 is preferably issued at the ascertained time. For example, the feedback request can be issued to the driver 104 or the vehicle occupants via the information display 108.

In step S204, the content of the feedback request can also be adapted based on the vehicle information. For example, based on the state of charge of the battery after the charging process, it is possible to question whether the charging process was successful from the point of view of the driver 102, especially if the state of charge has not changed or has only slightly changed during the charging process.

In addition, in step S204, the feedback situation can also be ascertained first based on the vehicle information, in particular a feedback situation for which a feedback request is to be made can be ascertained. For example, the feedback situation can be ascertained based on a state of charge of the battery of the vehicle 102. For example, if the state of charge has not changed or has only changed slightly during the charging process. Vehicle information may continue to be ascertained even after the feedback situation has been ascertained. After the feedback situation has been ascertained, ascertained vehicle information can thus be used to ascertain the time at which the feedback request is issued.

In addition, responses to issued feedback requests can continue to be transmitted as feedback information, in particular via the communication interface 144, for example to a central server. The feedback information can be used to identify recurring problems. The method ends in step S206.

The following text further explains an example of the method. First, vehicle information is ascertained, for example relating to interactions of the driver 104 or the vehicle occupants using the operator control elements 120 and the input unit 126, and relating to navigation destinations resulting from the interactions, for example the charging station 146. Reaching the charging station 146 can be recorded for example based on the position of the vehicle 102 as well as vehicle information, such as the charging process at the charging station 146. There, for example, a charging duration, charging power and changes in the state of charge of the battery of the vehicle 102 can be ascertained as vehicle information. First, the charging process can be ascertained as a feedback situation based on this vehicle information. A time for requesting feedback after the charging process could now be ascertained on this basis. Additional vehicle information can be ascertained for this purpose. For example, the driver's attention and upcoming driving maneuvers can be ascertained. In addition, the position of the vehicle 102 can be used to ascertain whether or not the vehicle 102 is in an urban environment. Based on this vehicle information, the time of the feedback request can be ascertained in such a way that the driver 104 or the vehicle occupants are not distracted by other tasks or driving maneuvers and the feedback request can be issued at an appropriate time. Thus, the time for the feedback request can be ascertained for example when the vehicle 102 has left the charging station 146 again, no driving maneuvers are imminent, the vehicle 102 is moving at a moderate, adapted speed and the driver 104 is not interacting with the operator control elements 120, 126. Furthermore, the content can be adapted to the feedback situation based on the vehicle information. For example, it can be ascertained that the charging process may have been terminated based on the charging duration and the state of charge. In this case, the feedback request could include whether the charging process was successful, whether there were technical problems, for example missing charging cables or no appropriate charging cables, or whether a payment process at the charging station 146 was unsuccessful. Feedback information based on responses to the feedback request can be transmitted to a central server to which further vehicles 102 of a vehicle fleet also transmit vehicle information. For example, defective charging stations 146 can thus be identified.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 Cockpit
102 Vehicle
104 Vehicle driver
106 Driver seat
108 Central information display
110 Head-up display
112 Graphical instrument cluster
114 Dashboard
118 Steering wheel
120 Operator control element
122 Gar selector switch
124 Pedals
126 Input unit
128 Windshield
132 Interior rearview mirror
134 Interior camera
138 Control unit
140 Data output
142 Data input
144 Communication interface
146 Charging station

What is claimed is:

1. A method for issuing a feedback request for a feedback situation of a vehicle, the method comprising:
ascertaining at least one item of vehicle information;
determining a time at which the feedback request is to be issued according to the feedback situation of the vehicle and based on the ascertained at least one item of vehicle information.

2. The method according to claim 1, wherein the feedback situation is ascertained based on the at least one item of vehicle information.

3. The method according to claim 1, wherein one or more of:
the at least one item of vehicle information comprises at least one item of information that is ascertained via a sensor of the vehicle;
the at least one item of vehicle information includes at least one item of information that is transmitted from an external device to the vehicle;
the at least one item of vehicle information includes at least one item of information relating to a charging station or fuel station; or
the at least one item of vehicle information includes at least one state of charge or fuel tank level.

4. The method according to claim 1, wherein
the feedback request is issued at a time when the vehicle is in an urban environment and is stationary; and/or
the feedback request is issued at a time when the vehicle is on a highway or in a rural environment and is in motion.

5. The method according to claim 1, wherein
content of the feedback request is determined based on the at least one item of vehicle information.

6. The method according to claim 1, wherein
the at least one item of vehicle information includes a driver's attention, and
the time of the feedback request is determined based on the driver's attention.

7. The method according to claim 1, wherein the feedback request is issued to a vehicle occupant.

8. The method according to claim 1, wherein
an item of feedback information is ascertained based on a response to the feedback request;
the feedback information is forwarded to other vehicles and/or to an evaluation unit.

9. The method according to claim 8, wherein
the at least one item of vehicle information includes at least the feedback information of a first feedback request, and
the time of further feedback requests is determined based on the item of feedback information.

10. A system for issuing a feedback request for a feedback situation of a vehicle, comprising:
a control unit operatively configured to:
ascertain at least one item of vehicle information;
determine a time at which the feedback request is to be issued according to the feedback situation of the vehicle and based on the ascertained at least one item of vehicle information.
